(19) United States
(12) Patent Application Publication
(10) Pub. No.: US 2025/0130106 A1
(43) Pub. Date: Apr. 24, 2025

(54) COMPACT SPECTROMETER

(71) Applicant: TRINAMIX GMBH, Ludwigshafen Am Rhein (DE)

(72) Inventors: Andre HORSAK, Ludwigshafen am Rhein (DE); Henning ZIMMERMANN, Ludwigshafen am Rhein (DE); Felix SCHMIDT, Ludwigshafen am Rhein (DE); Felix Berno MUELLER, Ludwigshafen am Rhein (DE); David KAESTEL, Ludwigshafen am Rhein (DE); Philipp SIEBRECHT, Ludwigshafen am Rhein (DE); Robert LOVRINCIC, Ludwigshafen am Rhein (DE); Daniel KAELBLEIN, Ludwigshafen am Rhein (DE)

(21) Appl. No.: 18/833,985

(22) PCT Filed: Feb. 24, 2023
(86) PCT No.: PCT/EP2023/054658

§ 371 Date: Jul. 29, 2024

(30) Foreign Application Priority Data
Feb. 25, 2022 (EP) 22158759.5

(51) Int. Cl. G01J 3/02; G01J 3/10; G01J 3/433

(52) U.S. Cl. CPC G01J 3/0256; G01J 3/108; G01J 3/433; G01J 2003/4332

(57) ABSTRACT

Disclosed herein is a spectrometer device for analyzing a sample. The spectrometer device includes at least one light emitting element; and at least one reference light emitting element. Further, the spectrometer device includes at least one interface element, at least one segmented aperture, and at least one optical separation element. Further, the spectrometer device includes at least one detector array including a plurality of detector elements.

Further disclosed herein are a spectrometer system, a method for determining at least one information related to a spectrum of a sample with the spectrometer device and various uses of a spectrometer system.

### TECHNICAL FIELD

The invention relates to a spectrometer device for analyzing a sample, a spectrometer system, a method for determining at least one information related to a spectrum of a sample with the spectrometer device and to various uses of the spectrometer system. Such methods and devices can, in general, be used for investigating or monitoring purposes, in particular, in the infrared (IR) spectral region, especially in the near-infrared (NIR) spectral region, and in the visible (VIS) spectral region, e.g. in a spectral region allowing to mimic a human's ability of color sight. However, further applications are feasible.

### BACKGROUND ART

In general, spectrometers are known to collect information on the spectral light composition from an object, when irradiating, reflecting and/or absorbing light. In order to achieve the collection of this information, typically, three steps are performed. Firstly, a dark signal of the detector of the spectrometer is determined by performing a first spectroscopy measurement without a sample. Secondly, a reference signal is obtained, by measuring, in a second measurement, a calibrated reflection, i.e. by measuring a standard sample. Thirdly, in a third measurement, the sample is measured and the measured sample signal is corrected by using the dark signal and normalized by using the reference signal.

Usually, in the spectrometer, the spectral information is obtained via dispersive optical elements, such as bandpass filters, gratings, filters or interferometers, in a combination with a detector, such as single pixel detectors, line array detectors or two-dimensional arrays. Further, in spectroscopy usually broad band emitting light sources, such as halogen-gas filled light bulbs and/or hot filaments, are used.

However, other light sources, such as light emitting diodes have also been proposed for the visible spectral region. As an example, US 2010/208261 A1 describes a device for determining at least one optical property of a sample. The device comprises a tuneable excitation light source for applying excitation light to the sample. The device furthermore comprises a detector for detecting detection light emerging from the sample. The excitation light source comprises a light-emitting diode array, which is configured at least partly as a monolithic light-emitting diode array. The monolithic light-emitting diode array comprises at least three light-emitting diodes each having a different emission spectrum.

U.S. Pat. No. 8,164,050 B2 describes a multi-channel source assembly for downhole spectroscopy that has individual sources that generate optical signals across a spectral range of wavelengths. A combining assembly optically combines the generated signals into a combined signal and a routing assembly that splits the combined signal into a reference channel and a measurement channel. Control circuitry electrically coupled to the sources modulates each of the sources at unique or independent frequencies during operation.

Further, U.S. Pat. No. 7,061,618 B2 describes integrated spectroscopy systems, wherein in some examples, integrated tunable detectors, using one or multiple Fabry-Perot tunable filters, are provided. Other examples use integrated tunable sources combining one or multiple diodes, such as superluminescent light emitting diodes (SLED), and a Fabry Perot tunable filter or etalon.

Furthermore, U.S. Pat. No. 5,475,221 A describes an optical device which uses an array of light emitting diodes, controlled by multiplexing schemes, to replace conventional broad band light sources in devices such as spectrometers.

WO 2018/203831 A1 discloses calibrating a spectrometer module. Calibrating includes performing measurements using the spectrometer module to generate wavelength-versus-operating parameter calibration data for the spectrometer module. Calibrating further comprises performing measurements using the spectrometer module to generate optical crosstalk and dark noise calibration data for the spectrometer module. Calibrating moreover includes performing measurements using the spectrometer module to generate full system response calibration data, against a known reflectivity standard, for the spectrometer module. The method further includes storing in memory, coupled to the spectrometer module, a calibration record that incorporates the wavelength-versus-operating parameter calibration data, the optical crosstalk and dark noise calibration data, and the full system response calibration data, and applying the calibration record to measurements by the spectrometer module.

WO 2017/040431 A1 discloses systems and methods for measuring a concentration and type of substance in a sample at a sampling interface. The systems include a light source, one or more optics, one or more modulators, a reference, a detector, and a controller. The systems and methods disclosed can be capable of accounting for drift originating from the light source, one or more optics, and the detector by sharing one or more components between different measurement light paths. Additionally, the systems can be capable of differentiating between different types of drift and eliminating erroneous measurements due to stray light with the placement of one or more modulators between the light source and the sample or reference. Furthermore, the systems can be capable of detecting the substance along various locations and depths within the sample by mapping a detector pixel and a microoptics to the location and depth in the sample.

WO 2021/042120 A1 describes an optical measurement device that may include a light source; an emission optic configured to direct a first portion of light generated by the light source to a measurement target; a collection optic configured to receive light from the measurement target; an optical conduit configured to direct a second portion of light generated by the light source to a spectral reference; the spectral reference; a sensor; and a filter. A first portion of the filter may be provided between the collection optic and a first portion of the sensor. A second portion of the filter may be provided between the spectral reference and a second portion of the sensor.

EP 2 267 420 A1 discloses a spectroscopic device. In the spectroscopic device, the reference beam path (R) and the measurement beam path (M) between the switch point and the detector entrance have the same light guide value and the same optical axis. Thus, the entrance aperture can be used almost completely. In a switch, a second permanent magnet is fixed away from the movable element in such a way that, in the relevant switching position, opposite magnetic poles of the first permanent magnet and the second permanent magnet face each other without contact and move away from each other whenever the movable element is deflected from the relevant switching position.

WO 2014/008359 A1 describes systems and techniques for optical spectrometer detection using, for example, IR spectroscopy components and Raman spectroscopy components. For instance, a system includes a first electromagnetic radiation source configured to illuminate a sample with a first portion of electromagnetic radiation in a first region of the electromagnetic spectrum (e.g., an IR source) and a second electromagnetic radiation source configured to illuminate a sample with a second portion of electromagnetic radiation in a second substantially monochromatic region of the electromagnetic spectrum (e.g., a laser source). The system also includes a detector module configured to detect a sample constituent of a sample by analyzing a characteristic of electromagnetic radiation reflected from the sample associated with the first electromagnetic radiation source and a characteristic of electromagnetic radiation reflected from the sample associated with the second electromagnetic radiation source.

Despite the advantages achieved by known methods and devices, and though, spectroscopy, in general, is a powerful analytical technique, enabling material classification, i.e. regardless of a material's color in the regime of visible light, and its prominent applications regard plastic recycling, identification of food or determination of food's nutrient contents, several technical challenges remain in the field of spectrometry and spectrometer devices. Specifically, in order to correct for inhomogeneity of the detector and/or optical components of the spectrometer, typically, measurements require a reference calibration, such as a calibration white standard, i.e. using a standard and/or reference sample. However, such a calibration is typically cumbersome and thus imposes a major limitation when transferring spectrometer applications from analytical labs to more complex environments, for example to widespread consumer applications.

Further, incandescent light sources and thermal emitters generally need a high level of energy, thus, leading to an overall high-energy consumption of spectrometer. In addition, these light sources tend to have a short lifetime and usually are sensitive to shock, vibrations and stress. Furthermore, stray light, such as in-band stray light and out-of-band stray light, typically limits spectrometer performance. The performance may specifically be limited due to the sample being irradiated with light in a wavelength range that is not of interest for the spectrometer measurement. Furthermore, common spectrometer components are usually bulky and require light collection optics.

### Problem to be Solved

It is therefore desirable to provide methods and devices, which at least partially address the above-mentioned technical challenges and at least substantially avoid the disadvantages of known methods and devices. In particular, it is an object of the present invention to provide methods and devices applicable in complex environments and aiming for being integrable into widespread consumer applications.

### SUMMARY

This problem is addressed by a spectrometer device for analyzing a sample, a spectrometer system, a method for determining at least one information related to a spectrum of a sample with the spectrometer device and to various uses of the spectrometer system. Advantageous embodiments which might be realized in an isolated fashion or in any arbitrary combinations are listed in the dependent claims as well as throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect, the present invention relates to a spectrometer device for analyzing a sample. The spectrometer device comprises:
at least one light emitting element configured for emitting light in a measurement spectrum;
at least one reference light emitting element, specifically at least one reference light emitting element separate from the at least one light emitting element, configured for emitting reference light in a reference spectrum;
at least one interface element, specifically a sample interface, configured for receiving light of the measurement spectrum and transferring light of the measurement spectrum to at least one detector array of the spectrometer device, wherein the interface element is further configured for blocking reference light of the reference spectrum;
at last one segmented aperture configured for acting as one or more of an angle filter, preferably as an angle filter for at least one dispersive element, and a straylight filter;
at least one optical separation element, specifically the at least one dispersive element, more specifically at least one linear variable filter element; and
the at least one detector array comprising a plurality of detector elements, wherein the detector array is configured for generating at least one detector signal according to an illumination of the plurality of detector elements by one or more of the measurement spectrum and the reference spectrum, wherein each detector element is configured for receiving at least a portion of one or more of the measurement spectrum and the reference spectrum.

As used herein, the term “spectrometer device” is a broad term and is to be given its ordinary and customary meaning to a person of ordinary skill in the art and is not to be limited to a special or customized meaning. The term specifically may refer, without limitation, to an apparatus that is capable of recording a signal intensity, i.e. an intensity of electromagnetic radiation, such as a light intensity, the signal being generated by the detector of the spectrometer device, with respect to a corresponding wavelength of the electromagnetic radiation, i.e. a wavelength of light, or a partition thereof. Therein, the signal intensity may, preferably, be generated by the detector as an electrical signal which may then be used for deriving an optical property of a sample.

The term “sample”, as used herein is a broad term and is to be given its ordinary and customary meaning to a person of ordinary skill in the art and is not to be limited to a special or customized meaning. The term specifically may refer, without limitation, to an arbitrary object or element, chosen from a living object or a non-living object, and having at least one optical property, the determination of the optical property, preferably, being of interest to a user when using the spectrometer device.

The spectrometer device comprises at least one light emitting element. As used herein, the term “light emitting element” is a broad term and is to be given its ordinary and customary meaning to a person of ordinary skill in the art and is not to be limited to a special customized meaning. The term may specifically refer to an element configured for emitting light. In particular, the light emitting element may be or may comprise at least one light source which is known to provide sufficient emission, i.e. for the spectrometer device to detect, in a predefined optical spectral range, i.e. in the visible spectral range and in the infrared spectral range, such as in the near-infrared and/or in the mid infrared and/or in the far infrared spectral range, specifically in a measurement spectrum. Specifically, the light emitting element may be selected from at least one of the following light sources: a thermal radiator, specifically an incandescent lamp or a thermal infrared emitter; a heat source; a laser diode, although further types of lasers can also be used; a light emitting diode (LED), in particular an organic light emitting diode; a miniaturized thin-film emitter; a structured light source.

Herein, the term “light” may generally refer to a partition of electromagnetic radiation which is, usually, referred to as “optical spectral range” and which specifically comprises one or more of the visible spectral range, the ultraviolet spectral range and the infrared spectral range. The terms “ultraviolet spectral” or “UV”, generally, refer to electromagnetic radiation having a wavelength of 1 nm to 380 nm, preferably of 100 nm to 380 nm. The term “visible”, generally, refers to a wavelength of 380 nm to 760 nm. The terms “infrared” or “IR”, generally, refer to a wavelength of 760 nm to 1000 μm, wherein a wavelength of 760 nm to 3 μm is, usually, denominated as “near infrared” or “NIR” while the wavelength of 3 u to 15 μm is, usually, denoted as “mid infrared” or “MidIR” and the wavelength of 15 μm to 1000 μm as “far infrared” or “FIR”. Light used for the typical purposes of the present invention may specifically be light in the IR spectral range, preferably in the NIR spectral range, more preferred having a wavelength of 800 nm to 3000 nm, even more preferred having a wavelength of 1100 nm to 2500 nm.

As generally used, the term “spectrum” may refer to a partition of the optical spectral range, in particular, the IR spectral range, especially at least one of the NIR or the MidIR spectral ranges. Each part of the spectrum is constituted by an optical signal which is defined by a signal wavelength and the corresponding signal intensity.

As outlined above, the light emitting element is configured for emitting light in a measurement spectrum. As used herein, the term “measurement spectrum” is a broad term and is to be given its ordinary and customary meaning to a person of ordinary skill in the art and is not to be limited to a special customized meaning. The term may specifically refer to a part of the spectrum in which the spectrometer device is configured to operate, such as in which the sample may be analyzed. In particular, the measurement spectrum may be or may comprise a partition of the optical spectral range in which the spectrometer device is capable of performing at least one measurement, such as analyzing the sample. Specifically, the measurement spectrum may be or may comprise a partition of the optical range in which the spectrometer device is capable of recording a signal intensity with respect to a corresponding wavelength of the electromagnetic radiation.

The spectrometer device further comprises at least one reference light emitting element. The reference light emitting element may specifically be separate from the at least one light emitting element. Thus, the reference light emitting element may be a separate element, i.e. separately arranged, from the at least one light emitting element. As used herein, the term “reference light emitting element” is a broad term and is to be given its ordinary and customary meaning to a person of ordinary skill in the art and is not to be limited to a special customized meaning. The term may specifically refer to an element configured for emitting reference light. In particular, the reference light emitting element may be or may comprise a light emitting element configured for emitting reference light, i.e. light in a reference spectrum. As used herein, the term “reference spectrum” may specifically refer to a part of the spectrum in which the spectrometer device is configured to be referenced, such as in which a functionality of one or more parts and/or components of the spectrometer device may be evaluated and/or verified. In particular, the reference spectrum may be or may comprise a partition of the optical range in which the spectrometer device is capable of recording a signal intensity with respect to a corresponding wavelength of the electromagnetic radiation. Specifically, the reference spectrum may be or may comprise a smaller and/or narrower partition of the optical spectral range than the measurement spectrum. Thus, the reference spectrum may be narrow compared to the measurement spectrum, i.e. have a smaller width of wavelength range than the measurement spectrum. In particular, the reference spectrum may differ from the measurement spectrum and thus may comprise of a different partition of the optical range than the measurement spectrum. As an example, the reference spectrum may be or may comprise electromagnetic radiation having smaller wavelengths them the electromagnetic radiation comprised in the measurement spectrum. Additionally or alternatively, it may also be possible that the reference spectrum and the measurement spectrum may at least partially overlap, i.e. share at least part of a partition of the optical spectral range.

As an example, the reference light emitting element may be or may comprise at least one light source which is known to provide sufficient emission in the reference spectrum, such as reference light, in order for the spectrometer device to detect. Specifically, the reference light emitting element may be selected from at least one of the following light sources: a thermal radiator, specifically an incandescent lamp or a thermal infrared emitter; a heat source; a laser diode, although further types of lasers can also be used; a light emitting diode (LED), in particular an organic light emitting diode; a miniaturized thin-film emitter; a structured light source.

The spectrometer device further comprises at least one interface element. The term “interface element” as used herein is a broad term and is to be given its ordinary and customary meaning to a person of ordinary skill in the art and is not to be limited to a special customized meaning. The term may specifically refer to an optical element configured for receiving and transferring electromagnetic radiation, specifically light, along an optical path, the optical path comprising at least one reflection, specifically a diffuse reflection, at the at least one sample. In particular, the interface element may be or may comprise a sample interface. Specifically, the at least one interface element may be configured for receiving light of the measurement spectrum and transferring the light of the measurement spectrum to a detector array of the spectrometer device.

Specifically, the at least one interface element may be configured for directly or indirectly receiving and/or transferring light of the measurement spectrum to the detector array. Thus, as an example, the interface element may receive and/or transfer light of the measurement spectrum directly, such as in a direct and/or un-interrupted, i.e. non-deflected, manner. Alternatively, however, the interface element may receive and/or transfer light of the measurement spectrum indirectly, such as via one or more of at least one further reflector, at least one optical fiber and/or at least one prism, to the detector array.

Further, the at least one interface element is configured for blocking reference light of the reference spectrum. As used herein, the term “blocking” is a broad term it is to be given its ordinary and customary meaning to a person of ordinary skill in the art and is not to be limited to a special customized meaning. The term specifically may refer, without limitation, to a process of a majority of electromagnetic radiation being stopped or blocked from passing through matter. In particular, the interface element being configured for blocking reference light of the reference spectrum, may specifically be configured for one or both of absorbing or reflecting ≥ 80% of the intensity of reference light, i.e. of light of the reference spectrum, from transmitting or passing through the interface element. Thus, the interface element being configured for blocking reference light of the reference spectrum, may specifically be configured for transmitting less than 20%, in particular less than 10%, more particular less than 5%, of reference light of the reference spectrum.

Further, the spectrometer device comprises at least one segmented aperture, the segmented aperture being configured for acting as one or more of an angle filter and a straylight filter. The term “segmented aperture” as used herein is a broad term and is to be given the ordinary and customary meaning to a person of ordinary skill in the art and is not to be limited to a special customized meaning. The time specifically may refer, without limitation, to a plurality of apertures arranged in a specific, predefined manner, such as in a parallel and/or lined up manner. In particular, the segmented aperture, such as a width and a height of each segment of the segmented aperture, may be configured for controlling and/or selecting light of a predefined angle to reach the detector array and/or the at least one optical separation element. Thus, the segmented aperture, specifically by its widths and height of the apertures, may be configured for guiding and/or controlling an optical path of the light that reaches the detector array, specifically the detector elements, and/or the optical separation element, such as a dispersive element. Specifically, the segmented aperture may be configured for limiting a solid angle of light received by the detector array.

Further, the spectrometer device comprises at least one optical separation element. The term “optical separation element” as used herein is a broad term and is to be given its ordinary and customary meaning to a person of ordinary skill in the art and is not to be limited to a special customized meaning. The term specifically may refer, without limitation, to an arbitrary optical element configured for separating and/or sourcing incoming light according to its wavelength. Particularly, in the spectrometer device, the optical separation element may be used for separating incident light into a spectrum of constituent wavelength signals whose respective intensities are determined by employing a detector array as described below in more detail. In particular, the optical separation element may specifically be or may comprise at least one dispersive element, such as at least one linear variable filter element. As used herein, the term “linear variable filter” may refer to an optical filter that comprises a plurality of filters, preferably a plurality of interference filters, which may, in particular, be provided in a continuous arrangement of the filters. Herein, each of the filters may form a bandpass with a variable center wavelength for each spatial position on the filter, preferably continuously, along a single dimension, on a receiving surface of the linear variable filter, wherein the variable center wavelength may specifically be a linear function of the spatial position on the filter.

Furthermore, the spectrometer device comprises at least one detector array. Specifically, the detector array comprises a plurality of detector elements. The term “detector array” as used herein is a broad term it is to be given its ordinary and customary meaning to person of ordinary skill in the art and is not to be limited to a special customized meaning. The term specifically may refer, without limitation, to a plurality of detector elements, wherein the term “plurality” particularly may refer to at least two, preferably at least four, more preferred at least eight, in particular at least sixteen, detector elements. The detector elements, as an example, may be arranged in a geometric fashion, such as in a matrix pattern and/or in a linear pattern, specifically in an equidistant row pattern. Further therein, the term “detector element” may specifically refer to an individual optical sensor, wherein each optical sensor may comprise at least one photosensitive area which is designated for recording a photoresponse of the detector element by generating at least one output signal, i.e. an electrical signal, that depends on an intensity of a portion of a wavelength signal of the electromagnetic radiation, i.e. light, illuminating the particular photosensitive area of the detector.

Further, the detector array is configured for generating at least one detector signal according to an illumination of the plurality of detector elements by one or more of the measurement spectrum and the reference spectrum. In particular, the detector signal may be provided in a pixel domain and in a frequency domain, wherein the detector signal may comprise at least one measurements detector signal generated by the detector array according to the measurement spectrum and a reference detector signal generated by the detector array according to the reference spectrum. In particular, each detector element of the detector array may be configured for receiving at least a portion of one or more of the measurement spectrum and the reference spectrum.

The detector array may be configured for generating at least one detector signal according to an illumination of the plurality of detector elements by the measurement spectrum. The detector array may further be configured for generating at least one detector signal according to an illumination of the plurality of detector elements by the reference spectrum. Each detector element may be configured for receiving at least a portion of the measurement spectrum and/or the reference spectrum.

The interface element, the reference light emitting element and the detector array may specifically be arranged such that the light emitted by the reference light emitting element travels to the detector array along an optical reference path, wherein the optical reference path may be fully arranged within the spectrometer device. As used herein, the term “optical reference path” may refer to an optical path comprising at least one partial reflection at the interface element. In particular, light following and/or traveling along the optical reference path may be emitted by the at least one reference light emitting element, may then be reflected at the at least one interface element and may subsequently illuminate the detector array of the spectrometer device. Thus the optical reference path may start at the reference light emitting element and may end at the detector array of the spectrometer device.

The interface element may be arranged such that the light, i.e. the reference light, emitted by the reference light emitting element is at least partially reflected by the interface element. Further, the interface element may be arranged and/or positioned such that the light emitted by the light emitting element is at least partially transmitted by the interface element. In particular, the light emitting element and the reference light emitting element may be arranged and/or positioned within a housing of the spectrometer device. Thus, as an example, the light emitting element and the reference light emitting element, both, may be positioned within a common enclosure, i.e. within the housing, of the spectrometer device. Further, the interface element and the light emitting element may particularly be arranged such that the light emitted by the light emitting element is transmitted by the interface element and that light reflected by the sample, i.e. after interaction with the sample, may be transmitted by the interface element, specifically towards the detector array. Furthermore, the interface element and the reference light emitting element may particularly be arranged such that the light, specifically the reference light, emitted by the reference light emitting element is reflected by the interface element, specifically towards the detector array.

The light emitting element may specifically be arranged for illuminating the sample. As an example, the light emitting element may be arranged for illuminating the sample through the interface element. Thus, the light emitting element may be arranged and/or positioned such that light emitted by the light emitting element, before illuminating the sample, may pass through the interface element, specifically at least partially.

The reference light emitting element may specifically be configured for providing the reference light to the detector array. In particular, the reference light may, after being emitted by the reference light emitting element, travel the optical reference path and may thereby, for example, be provided to the detector array.

The segmented aperture may be disposed in an optical path in between the interface element and the detector array. Specifically, the segment aperture may be disposed in between the interface element and the optical separation element.

The optical separation element may specifically be disposed in an optical path before the detector elements of the detector array. In particular, the optical separation element may be configured for separating light into a spectrum of constituent wavelength components, wherein each of the detector elements may be configured for receiving at least a portion of one of the constituent wavelength components and for generating a respective detector signal depending on the illumination of the respective detector element by the at least one portion of the respective constituent wavelength component.

The reference spectrum may specifically comprise light, i.e. electromagnetic radiation, having smaller wavelengths than light, i.e. electromagnetic radiation, comprised by the measurement spectrum. In particular, the at least one light emitting element may preferably be an LED. Furthermore, specifically additionally or alternatively, the at least one reference light emitting element may be an LED.

As an example, the at least one light emitting element and the reference light emitting element may both be or may comprise infrared LEDs configured for emitting light in an infrared spectral range, such that the measurement spectrum and the reference spectrum lie within the infrared spectral range, specifically in one or more of the near-infrared (NIR) and mid-infrared (MidIR) spectral ranges. In particular, the measurement spectrum and the reference spectrum may comprise light, i.e. electromagnetic radiation, having wavelengths within a range of 760 nm to 1000 μm.

In particular, the measurement spectrum may comprise light, i.e. electromagnetic radiation, having a wavelength λₘ, wherein 1000 nm≤λₘ≤15 μm, specifically 1050 nm≤λₘ≤3 μm, more specifically 1100 nm≤λₘ≤2500 nm.

Specifically, the reference spectrum may comprise light, i.e. electromagnetic radiation, having a wavelength λ_{ref}, wherein 760 nm≤λ_{ref}≤1000 nm, specifically 800 nm≤λ_{ref}≤900 nm, more specifically λ_{ref}=850 nm.

The spectrometer device may comprise a plurality of light emitting elements, specifically LEDs or miniaturized thin-film emitters, wherein each light emitting element may be configured for emitting light of a different portion of the measurement spectrum. In particular, the light of different portions of the measurement spectrum may comprise overlapping parts. Thus, the plurality of light emitting elements, specifically the plurality of LEDs or miniaturized thin-film emitters, may be configured such that each light emitting element may emit light at least partially having an overlapping spectrum with light emitted by other, for example neighboring, light emitting elements.

Each of the plurality of light emitting elements may specifically be an LED configured for emitting light of only one specific wavelength range within the measurement spectrum. The plurality of light emitting elements, specifically the plurality of LEDs, in conjunction may be configured for emitting light in contiguous wavelength spectral ranges of the measurement spectrum. In particular, the plurality of light emitting elements, specifically the plurality of LEDs, may be arranged along an axis of the detector array in an aligned fashion and may specifically be sorted in ascending or descending order of their emitted wavelengths. Furthermore, a number of light emitting elements, specifically a number of LEDs, may specifically correspond to a number of detector elements. In particular, each emitted portion of the measurement spectrum, i.e. emitted by the light emitting elements, may correspond to a received portion of the measurement spectrum received by one of the detector elements.

As an example, the plurality of light emitting elements, specifically a plurality of NIR LEDs, may be positioned along the segmented aperture of the spectrometer, i.e. along at least one side of the segmented aperture, preferably along a longer side of the segmented aperture. In particular, positioned in a predefined pattern, such as in an aligned fashion. Other arrangements may be possible. Further, the plurality of light emitting elements, specifically a plurality of NIR LEDs, may be positioned along the segmented aperture such that a distance and/or gap, i.e. a maximum distance, between the light emitting elements and the sample may be in the range from 0.5 mm to 40 mm, specifically from 1 mm to 20 mm, more specifically from 2 mm to 10 mm.

The detector array may comprise a PbS detector material, such that the detector array may specifically be configured for generating at least one detector signal according to an illumination by light in the infrared spectral range, specifically in the near-infrared spectral range. In particular, the detector array, such as the detector array comprising a PbS material, may be configured for detecting light having a wavelength in the range of 800 nm to 3000 nm. Thus, the detector array may be sensitive in the range from 800 nm to 3000 nm.

The interface element may comprise one or more of an optical filter, specifically an element having optical filtering properties, such as a bandpass filter and/or a longpass filter, and an optical reflector, such as a metal layer and/or a mirror, specifically a dichroic mirror.

In particular, the interface element may be configured for reflecting light of the reference spectrum, wherein the interface element further is configured for fully or partially transmitting light of the measurement spectrum. Specifically, the interface element further may be configured for blocking light having wavelengths≤1000 nm. In particular, the interface element may be configured for blocking light having wavelengths between 1 nm and 1000 nm. Furthermore, the interface element may comprise a silicon material, such as a silicon window, for example comprising Si.

As an example, the interface element may specifically act as a long pass filter for the reference light, i.e. for light in the reference spectrum. Furthermore, the interface element may act as an out-of-band light blocker, i.e. by blocking light outside of the desired measurement range.

The spectrometer device may further comprise at least one optical element selected from one or more of an optical reflector, a metal layer, a mirror, an optical filter and/or one or more optical lenses. In particular, the optical element may be configured for folding an optical path of the measurement spectrum, i.e. an optical measurement path, by an angle α, wherein 80°≤α≤100°, specifically α=90°.

A distance from the interface element to the detector array may for example be ≤40 mm, specifically ≤25 mm, more specifically ≤15 mm. Thus, as an example, from the interface element to the detector array, the light may travel a distance of less than 40 mm, specifically less than 24 mm, more specifically less than 15 mm.

The spectrometer device may further comprise at least one driving unit, e.g. an LED driver, configured for controlling the at least one light emitting element and the at least one reference light emitting element. Specifically, the at least one driving unit, such as the LED driver, may be configured for controlling the at least one light emitting element and the at least one reference light emitting element by one or more of: turning the light emitting element on and/or off, turning the reference light emitting element on and/or off, modulating the measurement spectrum and modulating the reference spectrum. In particular, the term “modulating” may refer to the process of adapting a frequency and/or a waveform of the emitted light.

The spectrometer device may further comprise at least one evaluation unit configured to generate the information related to the spectrum from the detector signal by calculating an absorbance, specifically an optical absorbance, of a sample from the detector signal depending on a location of the individual detector element in the detector array, e.g. in a pixel domain. Herein, the term “evaluation unit” may refer to an apparatus being designated for determining information related to the spectrum of the object of which a spectrum has been recorded, i.e. of the sample to be analyzed, in particular, by using the spectrometer device as described herein, wherein the information may specifically be obtainable by evaluating the detector signals as provided by the detector array of the spectrometer device. The information may, for example, be provided electronically, visually, acoustically or in any arbitrary combination thereof. Further, the information may be stored in a data storage device of the spectrometer device, preferably of a spectrometer system, or of a separate storage device and/or may be provided via at least one interface, such as a wireless interface and/or a wire-bound interface.

In a further aspect, the present invention relates to a spectrometer system. The spectrometer system comprises:
the spectrometer device according to the present invention, i.e. according to one or more of the embodiments disclosed herein; and
an electronics unit, separate from the spectrometer device and operatively couplable to the spectrometer device, configured for determining information regarding a spectrum by evaluating the at least one detector signal generated by the detector array of the spectrometer device.

In particular, the electronics unit may be or may comprise at least one data processor, such as a computer, a mobile device or a clouds device, configured for processing and/or storing data, such as the at least one detector signal. Specifically, the electronics unit, such as the data processor, i.e. a computer and/or mobile device, may be operatively couplable, i.e. able to be coupled, specifically reversibly couplable, to the spectrometer device via at least one wireless or wirebound interface, e.g. via Bluetooth. In particular, the at least one data processor may specifically be configured for processing and/or storing the calculated absorbance of the sample.

In a further aspect, the present invention relates to a method for determining at least one information related to a spectrum of a sample with the spectrometer device. With respect to the spectrometer device, reference may be made to the description elsewhere in this document. The method comprises the following steps that may be performed in the given order. However, a different order may also be possible. In particular, one, more than one or even all of the method steps may be performed once or repeatedly. Further, the method steps may be performed successively or, alternatively, to all more of the method steps may be performed in a timely overlapping fashion or even in parallel. The method may further comprise additional method steps that are not listed.

The method comprises the following steps:
a) providing the spectrometer device;
b) providing the sample;
c) emitting light in a measurement spectrum by the at least one light emitting element, specifically by the at least one LED or miniaturized thin-film emitter;
d) emitting light in a reference spectrum by the at least one reference light emitting element, specifically by at least one reference LED or miniaturized thin-film emitter;
e) generating the detector signal by the detector array, specifically a measurement detector signal and a reference detector signal, according to an illumination of the plurality of detector elements;
f) evaluating the at least one detector signal generated by the detector array of the spectrometer device, specifically by using the evaluation unit; and
g) determining the at least one information related to the spectrum of the sample.

Specifically, the spectrometer device as provided in step a) of the method for determining at least one information related to a spectrum of a sample with the spectrometer device is the spectrometer device as described above or as outlined in further detail below.

Step c) may comprise modulating the at least one light emitting element, such as for example the LED or miniaturized thin-film emitter. Specifically, the light emitting element may be modulated by using the driving unit, i.e. the driving unit of the spectrometer device. In particular, when modulating the at least one light-emitting element, the light emitted by the light emitting element may be modulated, such as by imprinting and/or assigning one or more predefined characteristics to the light, i.e. to a beam of the light emitted by the light emitting element.

Step d) may comprise modulating the reference light emitting element, such as for example the reference LED or miniaturized thin-film emitter. Specifically, the reference light emitting element may be modulated by using the driving unit, i.e. the driving unit of the spectrometer device. In particular, when modulating the at least one reference light emitting element, the reference light emitted by the reference light emitting element may be modulated, such as by imprinting answers or assigning one or more predefined characteristics to the reference light, i.e. to a beam of the reference light emitted by the reference light emitting element.

In particular, steps c) and d) of the method for determining a least one information related to a spectrum of a sample may preferably be performed in a timely overlapping fashion, such as simultaneously. Thus, the method may comprise at the same time emitting light in both the measurement spectrum and the reference spectrum. In this case, as an example, the detector array may generate the detector signal, i.e. in step e), simultaneously for both the measurement spectrum, i.e. as the measurement detector signal, and for the reference spectrum, i.e. as the reference detector signal. In particular, the measurement detector signal and the reference detector signal may specifically be distinguishable based on their specific waveform and/or frequency, i.e. based on a different modulation, i.e. as outlined above.

The method for determining at least one information related spectrum of a sample with the spectrometer device may further comprise:
h) calibrating, specifically by using the evaluation unit, the spectrometer device according to the detector signal generated in response to the reference light.

Step h) may be performed once or repeatedly during performing the method. Specifically, step h) may be performed at and any time between performing step a) and step g). Thus, step h) may be performed at least once after performing step a), such as subsequent to providing the spectrometer device. Additionally or alternatively, step h) may be performed at least once before performing step g), such as before determining the information related to the spectrum of the sample. As an example, step h) may be performed once or repeatedly before, after or even in parallel to performing any one of steps b) to f).

As an example, calibrating the spectrometer device may comprise comparing the detector signal generated in response to the reference light with a pre-determined or pre-defined signal, such as a standard signal, to be expected from the detector array in response to the reference light. Specifically, the pre-determined signal, i.e. the standard signal, may be compared to the reference detector signal, such as to the detector signal generated by the detector array according to the reference light. Thus, as an example, the standard signal may be compared to the signal generated by the detector elements positioned such that the reference light reaches these detector elements. Further, the calibrating may comprise considering a possible difference between the standard signal and the reference detector signal when determining the information related to the spectrum of the sample. As an example, the detector signal, specifically both the reference detector signal and the measurement detector signal, may be adapted such that the reference detector signal equals the standard signal, i.e. by introducing an offset, i.e. by using the evaluation unit. In particular, when calibrating the spectrometer device, for example by the evaluation unit, the possible difference between the reference detector signal and the standard signal may be used for adapting the measurement detector signal.

The at least one information related to the spectrum of the sample as determined in step g) of the method may specifically refer to an item of information, such as to one or more sets of data, on at least one property of the sample, i.e. on an optical property of the sample. Thus, the information may in particular allow for an analyzation and/or identification of the sample.

In particular, step g) may comprise calculating the absorbance of the sample. Specifically, in step g) the absorbance of the sample may be calculated by using the evaluation unit. Further, step g) may comprise processing the calculated absorbance of the sample. In particular, in step g) processing the calculated absorbance of the sample may be performed by using the evaluation unit and/or a data processor of a spectrometer system comprising the spectrometer device.

The absorbance of the sample may be calculated from the at least one detector signal, by using at least one predefined algorithm, i.e. a calculation approach. In particular, when using a plurality of light emitting elements, the detector signal may comprise a signal overlay, i.e. an overall signal or a mix of multiple signals. As an example, the plurality of light emitting elements, and optionally additionally the at least one reference light emitting element, may simultaneously emit light, wherein a simultaneous emittance of light may result in a simultaneous generation of the at least one detector signal according to the illumination, i.e. due to the emitted light, of the plurality of detector elements. Thus, for determining the absorbance of the sample, the at least one detector signal, i.e. the measurement detector signal and the reference detector signal, may be considered in both the pixel and the frequency domain, wherein the pixel domain may refer to a location of the detector element of the detector array, wherein the frequency domain may refer to a frequency of the light causing the respective detector signal.

In particular, when calculating the absorbance A the measurement detector signal may be denoted by S and the reference detector signal may be denoted by R, wherein the indices i and j may denote the pixel and the frequency domain, respectively. Further, the indice jₘₐₓ may refer to the frequency channel of the respective highest signal level per pixel. As an example, the absorbance A may be calculated by using the following equation (Eq. 1):

$${A}_{i} = - log ( \frac{{S}_{i , {j}_{max , , i}}}{{R}_{i , {j}_{max , , i}}} ) \qquad ( Eq . 1 )$$

Additionally or alternatively, the absorbance A may be calculated by using the following equation (Eq. 2):

$${A}_{i} = \frac{1}{n} \cdot {\sum }_{j = {f}_{1}}^{{f}_{n}} ( - log ( \frac{{S}_{i , j}}{{R}_{i , j}} ) \cdot \frac{{S}_{i , j}}{{S}_{i , {j}_{max , i}}} ) \qquad ( Eq . 2 )$$

Therein, n may refer to the total number of light emitting elements, such as to a total number of LEDs emitting light in the measurement spectrum. Further, f₁ to fₙ may refer to the respective frequency of the light emitted by the light emitting elements 1 to n. Additionally or alternatively, the absorbance A may be calculated by using the following equation (Eq. 3):

$${A}_{i} = - log ( \frac{{\sum }_{j = {f}_{1}}^{{f}_{n}} ( {S}_{i , j} )}{{\sum }_{j = {f}_{1}}^{{f}_{n}} ( {R}_{i , j} )} ) \qquad ( Eq . 3 )$$

Additionally or alternatively, the absorbance A may be calculated by using the following equation (Eq. 4):

$${A}_{i} = - log ( \frac{{\sum }_{j = {f}_{1}}^{{f}_{n}} ( \frac{{S}_{i , j}}{{\sum }_{j = {f}_{1}}^{{f}_{n}} ( {S}_{i , j} )} {S}_{i , j} )}{{\sum }_{j = {f}_{1}}^{{f}_{n}} ( \frac{{S}_{i , j}}{{\sum }_{j = {f}_{1}}^{{f}_{n}} ( {S}_{i , j} )} {R}_{i , j} )} ) \qquad ( Eq . 4 )$$

Further and/or other calculations, i.e. by using at least one different approach, are possible.

In a further aspect, the present invention relates to a use of a spectrometer system as described above as outlined in further detail below. In particular, a use of the spectrometer system is proposed in an application selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; a healthcare and/or beauty application, in particular a determining of skin hydration and/or oxygen saturation, e.g. in an animal or human skin, a determining of an oxygen saturation in blood, urine, saliva or other bodily fluids.

The described spectrometer device, the spectrometer system, the method and the proposed uses have considerable advantages over the prior art. Thus, in particular, the present devices, systems and methods may allow for more sustainable and environmentally friendly sample analyzation, than known devices, systems and methods. In particular, and specifically in the NIR spectral range, the present devices, systems and methods may reduce rare material and energy consumption compared to known methods and devices, for example usually using rare earth and/or rare metal detectors materials along with high power consuming emitters, i.e. halogen-gas filled light bulbs. In particular, the present devices, systems and methods, i.e. by using LEDs for emitters, may allow for a lower power consumption than known devices, systems and methods. Specifically, a lower power consumption may be achieved when comparing a specific power consumption per irradiance to a black body emitter.

Furthermore, the present devices, systems and methods may allow for a more compact built, i.e. may be smaller and may need less space, than known methods and devices. Specifically, the present devices, systems and methods, for example by using LEDs for emitters, might allow for decreasing the distances, such as the distances in the optical path way of the spectrometer, to a few millimeters between both light source and sample as well as sample and detector. In particular, the present devices, systems and methods may thus allow for a high degree of miniaturization and/or a very compact built, i.e. a very compact design. As an example, the present devices, systems and methods, i.e. by allowing for a more compact built compared to known devices, may be able to reduce a setup size of the spectrometer device to a footprint of the detector and a height of a few millimeters.

The present devices, systems and methods may help enable mobile application of spectroscopy, i.e. diffusive reflective spectroscopy, specifically in the near infrared spectral range, for example in smart phones and/or at the wearable or portable devices, thereby allowing for a widespread application of spectroscopy. In addition, the more compact built of the present devices, systems and methods may further decrease power consumption compared to known devices and methods.

The present devices, systems and methods may, for example, combine advantages from known dispersive spectrometers, wherein a sample and/or specimen may be illuminated with a single wavelength at a time and the absorption may be measured wavelength by wavelength, with the advantages known from a standard spectrometer approach, wherein first a dark signal may be determined, then a reference signal may be obtained, i.e. by using a standard reflection sample, and subsequently a sample may be measured.

Further, the present devices, systems and methods may allow for refusing a risk of erroneous measurements by increasing accuracy and precision of spectroscopic measurements. In particular, the present devices, systems and methods may increase measurement precision by reducing stray light, i.e. out of band stray light and/more in band stray light, to a minimum, for example by using LEDs for emitters. In particular, spectral performance may be increased by the present devices, systems and methods, for example by using LEDs that may emitting power only in one specific wavelength range, compared to known devices, systems and methods.

In particular, the present devices, systems and methods may allow the measurement and/or analyzation of a sample without the need to measure a reflection standard sample. As an example, the present devices, systems and methods may allow performing a diffusive reflective spectroscopy without the need to measure a diffusive reflective standard sample, e.g. by providing an optical reference path, i.e. a build-in reference channel. Specifically, cumbersome and time-consuming calibration steps, for example requiring a reflection standard sample, as necessary with known methods and devices, may not be necessary with present devices, systems and methods. In particular, no calibrated reference standard may be necessary. Furthermore, i.e. by allowing reference light to travel an optical reference path, such as an integrated reference channel, built-in reference measurement may be unnecessary. In particular, the present device, systems and methods may allow performance of a reference measurement, such as via the optical reference path, i.e. in an integrated reference channel, while simultaneously allowing to analyze a sample, i.e. performing a measurement of the sample.

Furthermore, the devices, systems and methods may be less prone to failure than known devices and methods. In particular, i.e. by using LEDs for emitters, the devices, systems and methods may be mechanically insensitive and may allow for a longer lifetime of the devices compared to known devices. Thus, the devices, systems and methods may decrease the possibility of measurement errors due to component failure or degradation.

Summarizing, in the context of the present invention, and without excluding further possible embodiment, the following embodiments may be envisaged:

Embodiment 1: A spectrometer device for analyzing a sample, comprising:
at least one light emitting element configured for emitting light in a measurement spectrum;
at least one reference light emitting element, specifically at least one reference light emitting element separate from the at least one light emitting element, configured for emitting reference light in a reference spectrum;
at least one interface element, specifically a sample interface, configured for receiving light of the measurement spectrum and transferring light of the measurement spectrum to at least one detector array, wherein the interface element is further configured for blocking reference light of the reference spectrum;
at last one segmented aperture configured for acting as one or more of an angle filter, preferably as an angle filter for a dispersive element, and a straylight filter;
at least one optical separation element, specifically the at least one dispersive element, more specifically at least one linear variable filter element; and
the at least one detector array comprising a plurality of detector elements, wherein the detector array is configured for generating at least one detector signal according to an illumination of the plurality of detector elements by one or more of the measurement spectrum and the reference spectrum, wherein each detector element is configured for receiving at least a portion of one or more of the measurement spectrum and the reference spectrum.

Embodiment 2: The spectrometer device according to the preceding embodiment, wherein the interface element, the reference light emitting element and the detector array are arranged such that the light emitted by the reference light emitting element travels to the detector array along an optical reference path, wherein the optical reference path is fully arranged within the spectrometer device.

Embodiment 3: The spectrometer device according to the preceding embodiment, wherein the interface element is arranged such that the light emitted by the reference light emitting element is at least partially reflected by the interface element and that the light emitted by the light emitting element is at least partially transmitted by the interface element.

Embodiment 4: The spectrometer device according to the preceding embodiment, wherein the light emitting element and the reference light emitting element are arranged within a housing of the spectrometer device, wherein the interface element and the light emitting element are arranged such that the light emitted by the light emitting element is transmitted by the interface element and that light reflected by the sample is transmitted by the interface element, specifically towards the detector array, wherein the interface element and the reference light emitting element are arranged such that the light emitted by the reference light emitting element is reflected by the interface element, specifically towards the detector array.

Embodiment 5: The spectrometer device according to any one of the preceding embodiments, wherein the light emitting element is arranged for illuminating the sample, specifically through the interface element.

Embodiment 6: The spectrometer device according to any one of the preceding embodiments, wherein the reference light emitting element is configured for providing the reference light to the detector array.

Embodiment 7: The spectrometer device according to any one of the preceding embodiments, wherein the segmented aperture is disposed in an optical path in between the interface element and the detector array, specifically in between the interface element and the optical separation element.

Embodiment 8: The spectrometer device according to any one of the preceding embodiments, wherein the segmented aperture is configured for limiting a solid angle of light received by the detector array.

Embodiment 9: The spectrometer device according to any one of the preceding embodiments, wherein the optical separation element is disposed in an optical path before the detector elements of the detector array, wherein the optical separation element is configured for separating light into a spectrum of constituent wavelength components, wherein each of the detector elements is configured for receiving at least a portion of one of the constituent wavelength components and for generating a respective detector signal depending on the illumination of the respective detector element by the at least one portion of the respective constituent wavelength component.

Embodiment 10: The spectrometer device according to any one of the preceding embodiments, wherein the reference spectrum comprises electromagnetic radiation having smaller wavelengths than electromagnetic radiation comprised by the measurement spectrum.

Embodiment 11: The spectrometer device according to any one of the preceding embodiments, wherein the at least one light emitting element is a light emitting diode (LED).

Embodiment 12: The spectrometer device according to any one of the preceding embodiments, wherein the at least one reference light emitting element is a light emitting diode (LED).

Embodiment 13: The spectrometer device according to any one of the two preceding embodiments, wherein the at least one light emitting element and the reference light emitting element are infrared LEDs configured for emitting light in an infrared spectral range, such that the measurement spectrum and the reference spectrum lie within the infrared spectral range, specifically in one or more of the near-infrared (NIR) and mid-infrared (MidIR) spectral ranges.

Embodiment 14: The spectrometer device according to the preceding embodiment, wherein the measurement spectrum comprises electromagnetic radiation having a wavelength λₘ, wherein 1000 nm≤λₘ≤15 μm, specifically 1050 nm≤λₘ≤3 μm, more specifically 1100 nm≤λₘ≤2500 nm.

Embodiment 15: The spectrometer device according to any one of the two preceding embodiments, wherein the reference spectrum comprises electromagnetic radiation having a wavelength λ_{ref}, wherein 760 nm≤λ_{ref}≤1000 nm, specifically 800 nm≤λ_{ref}≤900 nm, more specifically λ_{ref}=850 nm.

Embodiment 16: The spectrometer device according to any one of the preceding embodiments, wherein the spectrometer device comprises a plurality of light emitting elements, specifically LEDs or miniaturized thin-film emitters, wherein each light emitting element is configured for emitting light of a different portion of the measurement spectrum.

Embodiment 17: The spectrometer device according to the preceding embodiment, wherein each of the plurality of light emitting elements is an LED configured for emitting light of only one specific wavelength range within the measurement spectrum.

Embodiment 18: The spectrometer device according to any one of the two preceding embodiments, wherein the plurality of light emitting elements, specifically the plurality of LEDs, in conjunction are configured for emitting light in contiguous wavelength spectral ranges of the measurement spectrum.

Embodiment 19: The spectrometer device according to any one of the three preceding embodiments, wherein the plurality of light emitting elements, specifically the plurality of LEDs, are arranged along an axis of the detector array in an aligned fashion and are sorted in ascending or descending order of their emitted wavelengths.

Embodiment 20: The spectrometer device according to any one of the four preceding embodiments, wherein a number of light emitting elements, specifically a number of LEDs, corresponds to a number of detector elements, wherein each emitted portion of the measurement spectrum corresponds to a received portion of the measurement spectrum received by one of the detector elements.

Embodiment 21: The spectrometer device according to any one of the preceding embodiments, wherein the detector array comprises a PbS detector material, such that the detector array is configured for generating at least one detector signal according to an illumination by light in the infrared spectral range, specifically in the near-infrared spectral range.

Embodiment 22: The spectrometer device according to any one of the preceding embodiments, wherein the interface element comprises one or more of an optical filter, specifically an element having optical filtering properties, such as a bandpass filter and/or a longpass filter, and an optical reflector, such as a metal layer and/or a mirror, specifically a dichroic mirror.

Embodiment 23: The spectrometer device according to the preceding embodiment, wherein the interface element is configured for reflecting light of the reference spectrum, wherein the interface element further is configured for fully or partially transmitting light of the measurement spectrum.

Embodiment 24: The spectrometer device according to any one of the two preceding embodiments, wherein the interface element further is configured for blocking light having wavelengths ≤1000 nm.

Embodiment 25: The spectrometer device according to any one of the three preceding embodiments, wherein the interface element comprises a silicon material, such as a silicon window, for example comprising Si.

Embodiment 26: The spectrometer device according to any one of the preceding embodiments, wherein the spectrometer device further comprises at least one optical element selected from one or more of an optical reflector, a metal layer, a mirror, an optical filter and/or one or more optical lenses.

Embodiment 27: The spectrometer device according to the preceding embodiment, wherein the optical element is configured for folding an optical path of the measurement spectrum, i.e. an optical measurement path, by an angle α, wherein 80°≤α≤100°, specifically α=90°.

Embodiment 28: The spectrometer device according to any one of the preceding embodiments, wherein a distance from the interface element to the detector array is ≤40 mm, specifically ≤25 mm, more specifically ≤15 mm.

Embodiment 29: The spectrometer device according to any one of the preceding embodiments, further comprising at least one driving unit, e.g. an LED driver, configured for controlling the at least one light emitting element and the at least one reference light emitting element by one or more of: turning the light emitting element on and/or off, turning the reference light emitting element on and/or off, modulating the measurement spectrum and modulating the reference spectrum.

Embodiment 30: The spectrometer device according to any one of the preceding embodiments, further comprising at least one evaluation unit configured to generate the information related to the spectrum from the detector signal by calculating an absorbance of a sample from the detector signal depending on a location of the individual detector element in the detector array, e.g. in a pixel domain.

Embodiment 31: A spectrometer system, comprising:
the spectrometer device according to any one of the preceding embodiments; and
an electronics unit configured for determining information regarding a spectrum by evaluating the at least one detector signal generated by the detector array of the spectrometer device.

Embodiment 32: The spectrometer system according to the preceding embodiment, wherein the electronics unit comprises at least one data processor, such as a PC, a mobile device or a cloud device, configured for processing and/or storing data, such as the at least one detector signal.

Embodiment 33: The spectrometer system according to the preceding embodiment, wherein the at least one data processor is configured for processing and/or storing the calculated absorbance of the sample.

Embodiment 34: A method for determining at least one information related to a spectrum of a sample with the spectrometer device according to any one of the preceding embodiments referring to a spectrometer device, the method comprising:
a) providing the spectrometer device;
b) providing the sample;
c) emitting light in a measurement spectrum by the at least one light emitting element, specifically by the at least one LED or miniaturized thin-film emitter;
d) emitting light in a reference spectrum by the at least one reference light emitting element, specifically by at least one reference LED or miniaturized thin-film emitter;
e) generating the detector signal by the detector array, specifically a measurement detector signal and a reference detector signal, according to an illumination of the plurality of detector elements;
f) evaluating the at least one detector signal generated by the detector array of the spectrometer device, specifically by using the evaluation unit; and
g) determining the at least one information related to the spectrum of the sample.

Embodiment 35: The method according to the preceding embodiment, wherein step c) comprises modulating the light emitting element, specifically the LED or miniaturized thin-film emitter, specifically by using the driving unit.

Embodiment 36: The method according to any one of the two preceding embodiments, wherein step d) comprises modulating the reference light emitting element, specifically the reference LED or miniaturized thin-film emitter, specifically by using the driving unit.

Embodiment 37: The method according to any one of the three preceding embodiments, wherein step g) comprises calculating the absorbance of the sample, specifically by using the evaluation unit, and processing the calculated absorbance of the sample, specifically by using the evaluation unit and/or a data processor of a spectrometer system comprising the spectrometer device.

Embodiment 38: The method according to any one of the four preceding embodiments, wherein the method further comprises:
h) calibrating, specifically by using the evaluation unit, the spectrometer device according to the detector signal generated in response to the reference light.

Embodiment 39: A use of a spectrometer system according to any one of the preceding embodiments referring to a spectrometer system, in an application selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; a healthcare and/or beauty application, in particular a determining of skin hydration and/or oxygen saturation, e.g. in an animal or human skin, a determining of an oxygen saturation in blood, urine, saliva or other bodily fluids.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1 and 2 show embodiments of a spectrometer device in a schematic overview;

FIGS. 3 to 5 show different embodiments of parts of a spectrometer device in perspective views;

FIG. 6 shows an embodiment of a spectrometer device in a schematic side view;

FIGS. 7a to 8b show different embodiments of parts of a spectrometer device in schematic side views;

FIG. 9 shows an embodiment of a spectrometer system in a schematic overview;

FIGS. 10a and 10b show graphs of measurement signals of light emitted by a plurality of light emitting elements of a spectrometer device;

FIG. 11 shows a flow chart of a method for determining at least one information related to a spectrum of a sample;

FIG. 12 shows a graph of a plurality of measurement signals; and

FIGS. 13 and 14 show graphs of different calculated absorbances of a PET sample.

### DETAILED DESCRIPTION OF THE EMBODIMENTS

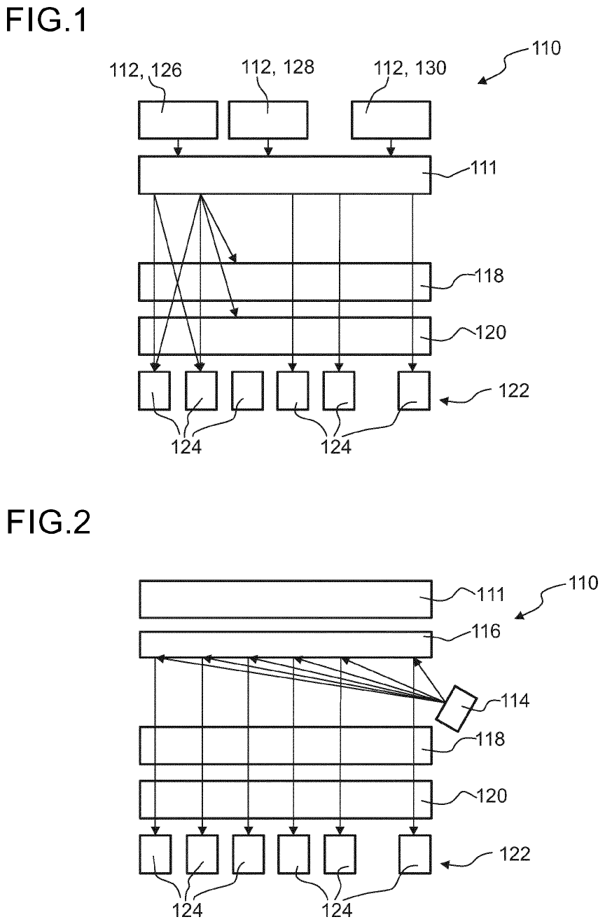

FIGS. 1 and 2 illustrate, in a highly schematic fashion, an embodiment of a spectrometer device 110 for analyzing a sample 111. The spectrometer device comprises at least one light emitting element 112 and at least one reference light-emitting element 114, wherein for illustrational purposes light emitting elements 112 are only shown in FIG. 1, but not in FIG. 2, and reference light emitting elements 114 are only shown in FIG. 2, but not in FIG. 1. Further, the spectrometer device 110 comprises at least one interface element 116, at least one segmented aperture 118 and at least one optical separation element 120. Furthermore, the spectrometer device 110 comprises at least one detector array 122 comprising a plurality of detector elements 124.

The at least one light-emitting element 112 is configured for emitting light in a measurement spectrum, wherein as an example a plurality of light-emitting elements 112, i.e. a plurality of LEDs, may be present in the spectrometer device 110, as exemplarily illustrated in FIG. 1. In particular, the plurality of light-emitting elements 112, i.e. the plurality of LEDs, may be configured for in conjunction emitting light in contiguous wavelength spectral ranges of the measurement spectrum. Thus, as an example, a first light-emitting element 126 may be configured for emitting light in a first wavelength spectral range, wherein a second and third light emitting elements 128, 130 may be configured for emitting light in a second and third wavelength spectral range, respectively. The at least one interface element 116, not illustrated in FIG. 1 for illustrational purposes, is configured for receiving light of the measurement spectrum. Thus, the interface element 116 may specifically receive the light emitted by the light-emitting element 112, i.e. the plurality of contiguous wavelength spectral ranges for example admitted by the first, second and third light-emitting elements 126, 128, 130. In particular, and as exemplarily illustrated in FIG. 1, the sample 111 may be illuminated by using a set of different light emitting elements 112, such as infrared sources. As an example, the different light emitting elements 112 may be located at different locations within the spectrometer device 110.

Further, the interface element 116 is configured for transferring the light of the measurement spectrum to the detector array 122. In particular, the light, before reaching the detector array 122, may first have to pass both the at least one segmented aperture 118 and the at least one optical separation element 120, wherein specifically the segmented aperture is configured for acting as one or more of an angle filter and a straylight filter. As an example, the spectrometer device 110 may be configured such that only light of a predefined angle and wavelength may pass the segmented aperture 118, i.e. an angle filter, and the optical separation element, i.e. a dispersive element, and thus, may reach the detector array 122. In FIG. 1, possible optical paths for the measurement light are illustrated by using arrows. Thus, as an example, the light emitted by the first light emitting element 126 may have to pass the segmented aperture 118, i.e. the angle filter, with a correct angle, i.e. with an angle within a predefined range, and may further have to pass the optical separation element 120, i.e. the dispersive element, with a correct wavelength, i.e. having a wavelength within a predefined range. In particular, light having a wavelength outside of the allowable wavelength range may be blocked by the optical separation element 120, as exemplarily illustrated in FIG. 1 by the arrow ending at the optical separation element 120. Furthermore, light reaching the segmented aperture 118 with an angle outside of the allowable angle range may be blocked by the segmented aperture 118, as exemplarily illustrated in FIG. 1 by the arrow ending at the segmented aperture 118.

The at least one reference light emitting element 114 is configured for emitting light in a reference spectrum, specifically reference light, wherein the interface element 116 is configured for blocking the reference light. Thus, in particular, the interface element 116 may be configured for stopping reference light from transmitting through the interface element 116, but instead may reflect the reference light of the reference spectrum to the detector array 122. In particular, the reference light, before reaching the detector array 122, may first have to pass both the at least one segmented aperture 118 and the at least one optical separation element 120. In FIG. 2, possible optical paths for the reference light are illustrated by using arrows. As an example, the interface element 116, specifically the sample interface, may act as a long pass filter. Thus, in case the reference spectrum comprises of a smaller wavelength range, i.e. has a smaller wavelength, than the measurement spectrum, light of the reference spectrum may be blocked and reflected at the interface element 116, specifically at the sample interface, and may further be able to pass the segmented aperture 118, i.e. the angle filter, everywhere. Further, the optical separation element 120, i.e. the dispersive element, may have a specifically high transmission of the reference light, e.g. may transmit light of the reference spectrum. Thus, as an example, the reference light might reach most of or even all pixels, i.e. the detector elements 124 of the detector array 122. In particular, the reference light emitting element 114, i.e. the source of the reference light, may be modulated at another frequency than the light emitting elements 112, i.e. than all other light sources. Thereby, as an example, the spectrometer device 110 may be configured for performing both referencing and analyzing of the sample at the same time, i.e. simultaneous measurement of reference and sample may be enabled.

The detector array 122 is configured for generating at least one detector signal according to an illumination of the plurality of detector elements 124 by one or more of the measurement spectrum and the reference spectrum, wherein each detector element is configured for receiving at least a portion of one or more of the measurement spectrum and the reference spectrum. In particular, the detector elements 124 of the detector array 122 may be configured for generating signals corresponding to the light, i.e. the light within different wavelength spectral ranges, reaching the detector elements 124 after having passed both the segmented aperture 118 and the optical separation element 120.

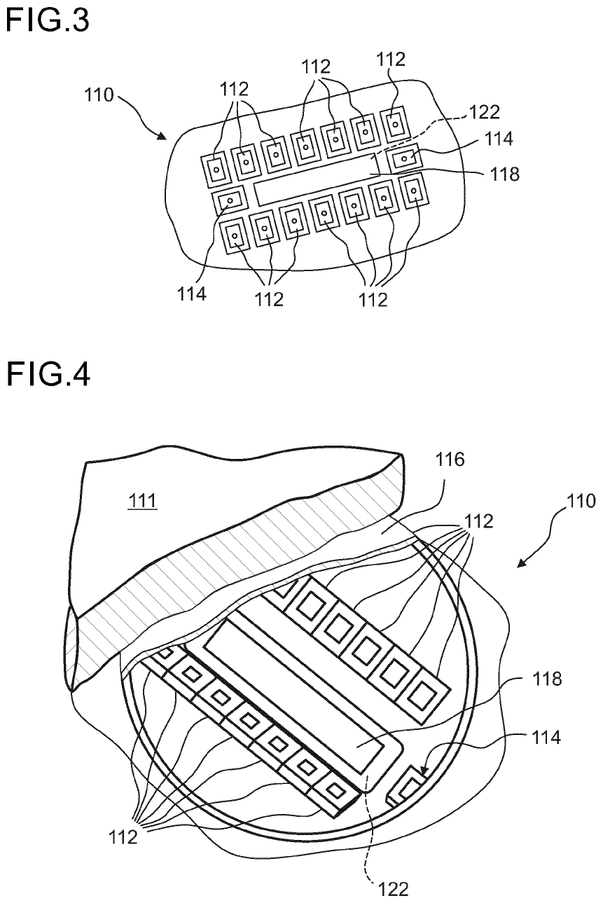

In FIGS. 3 to 5, different embodiments of parts of the spectrometer device 110 are illustrated in perspective views. In particular, the spectrometer device may comprise a plurality of light emitting elements 112 arranged in an aligned fashion along an axis of the detector array 122, i.e. arranged to both sides of a longer axis of the detector array 122. Due to the perspective view, in FIGS. 3 and 4, the detector array 122 arranged underneath the segmented aperture 118 is covered by the segmented aperture 118 and thus is not shown. In particular, the plurality of light emitting elements 122 may be arranged according to the spectral range of lights emitted from the light emitting elements 122, i.e. depending on their specific wavelength range. As an example, the light emitting elements 122 may be arranged along a long side of the detector array 122 in order from short to long wavelengths, such that the light emitting element 122 emitting light of the shortest wavelength within the measurement spectrum may be placed, i.e. at the end of the detector array 122, where the detector element 124 that is configured for detecting the shortest wavelengths is positioned. Further, the at least one reference light emitting element 114 of the spectrometer device 110 may be arranged next to the detector array 122, i.e. within the long axis, such as on a short side of the detector array 122. Other arrangements are possible.

Further, and specifically for analyzing the sample 111, the at least one interface element 116 may be arranged such as to cover the at least one light emitting element 112, the at least one reference light emitting element 114, the at least one segmented aperture 118, the at least one optical separation element 120 and the detector array 122 of the spectrometer device 110. In particular, and as exemplarily illustrated in FIG. 4, the sample 111, specifically the sample to be analyzed by using the spectrometer device 110, may be placed on top of the interface element 116.

The spectrometer device 110 may further comprise at least one optical element 132, such as an optical reflector, a metal layer, a mirror 134, an optical filter and/or one or more optical lenses. Specifically, the optical element 132 may be configured for folding and optical path of the measurement spectrum, by an angle α. Specifically, and as exemplarily illustrated in FIG. 5, the optical element 132 may be or may comprise a mirror 134, wherein the angle α is denoted with reference number 136. As in previous figures, a possible optical path for the measurement light emitted by the light emitting elements 112, is illustrated in FIG. 5 by using an arrow. As an example, light traveling different optical paths may be reflected and/or blocked by the segmented aperture 118, specifically by reflective surfaces, i.e. by further optical elements 132. As an example, these further optical elements 132 may specifically be arranged in a 45° and/or in a 90° angle with respect to an entrance opening 138 allowing light to pass through. As an example, light emitted from the light emitting elements 112 may be transmitted from the interface element 116 towards the segmented aperture 118, where straylight, specifically light reaching the segmented aperture 118 outside of the entrance opening 138 may be absorbed and/or reflected, i.e. reflected in a 90° angle. The light may pass the segmented aperture 118 through an exit opening 140. As an example, one or both of the entrance opening 138 and the exit opening 140 may be or may comprise a hole, such as a material gap or void. Alternatively, the entrance opening 138 and the exit opening 140 may be or may comprise a material transparent for light of the measurement range and/or the reference range, i.e. configured for transmitting light of these ranges.

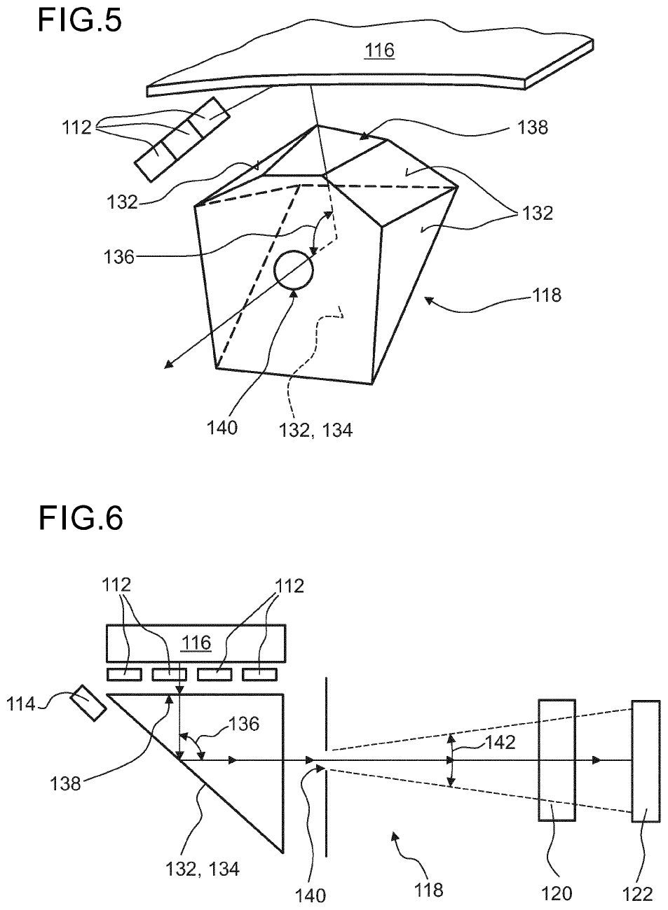

In FIG. 6, an embodiment of a spectrometer device 110 is illustrated in a schematic side view. Specifically, the spectrometer device 110 may comprise the optical element 132, specifically the mirror 134, for folding an optical path by the angle α 136, i.e. by 90°. Subsequently, the light may pass the segmented aperture 118, wherein only light with an angle smaller or equal to an angle θ (denoted by reference number 142) may pass the segmented aperture 118. Again, as in previous figures, a possible optical path for the measurement light emitted by the light emitting element 112, is illustrated in FIG. 6 by using arrows. As an example, the folding of the optical path, i.e. by using the mirror 134, may specifically allow for a reduced height of the spectrometer device 110 compared to setups without folding of the optical path.

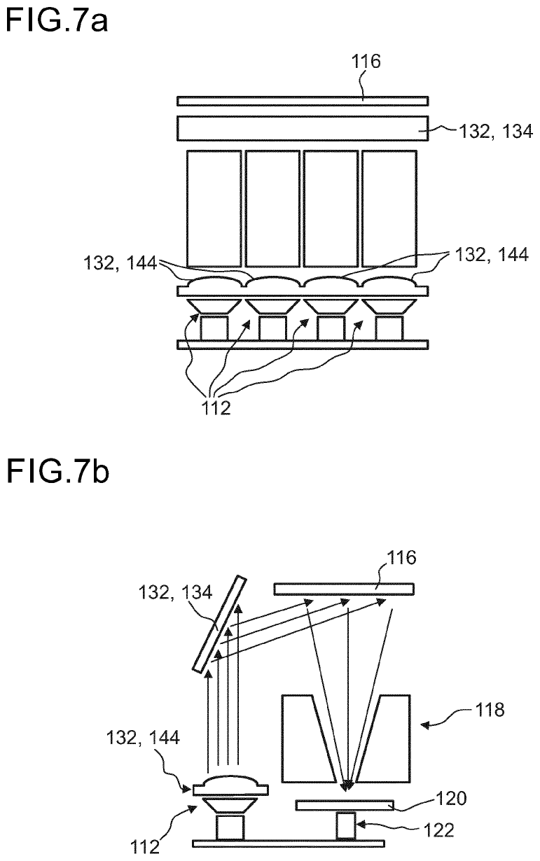

FIGS. 7a to 8b show different embodiments of parts of a spectrometer device 110 in schematic side views, wherein FIGS. 7b and 8b are right side views of FIGS. 7a and 8a, respectively. In particular, each of the light emitting elements 112, as exemplarily illustrated in FIG. 7a, may be configured for emitting light of a different portion of the measurement spectrum. Again, as in previous figures, possible optical paths for the measurement light emitted by the light emitting elements 112, are illustrated in FIG. 7b by using arrows. As an example, the spectrometer device 110 may further comprise a plurality of optical lenses 144, i.e. a microlens array, as further optical element 132. In particular, the plurality of optical lenses 144, specifically the microlens array, may be arranged on top of the light emitting elements 112, as is asked temporarily illustrated in FIGS. 7a and 7b. The plurality of optical lenses 144, specifically the microlens array, may be used for collecting and/or collimating the light emitted from the light emitting elements 112. Subsequently, the light may be reflected onto the sample 111 and/or onto the interface element 116, by using the mirror 134. In particular, a set up of the spectrometer device 110, specifically an arrangement of the light emitting elements 112, may be identical on both sides of the detector array 122. Thus, as an example, an identical illumination setup, as illustrated on the left side in FIG. 7b, might be placed on the right-hand side of the detector array 122 in this Figure, i.e. on a short axis of the detector array 122. The reference light emitting element 114 might specifically be placed in the long axis next to the detector array 122, as exemplarily illustrated in FIGS. 3, 4 and 8b. This set up of the reference light emitting element 114 might specifically be beneficial for having the reference light reflected onto the entire detector array 122.

As an example, the segmented aperture 118 may be cone-shaped, i.e. with an upper slit width being broader than a lower slit width, as exemplarily illustrated in FIGS. 7b and 8b. This may specifically lead to a waist of a cone formed by the light, i.e. a waist of a light cone, to be at the surface of the detector array 122. With regard to a longer axis of the detector array 122, the light passing a single segment of the segmented aperture 118 may specifically distribute over multiple detector elements 124, i.e. over multiple pixels. Thus, as exemplarily illustrated in FIG. 8a, the segmented aperture 118 may in a direction of the longer axis of the detector array 122 comprise multiple segments, wherein the angle θ 142 may specifically depend on, i.e. be limited due to, a quotient of a width and height of each of the multiple segments of the segmented aperture 118. In particular, the angle θ 142 may have a direct influence on optical resolution of the optical separation element 120, i.e. of the dispersive element. Thus, as an example, the larger the angle θ 142 may be, the lower may be the optical resolution of the optical separation element 120.

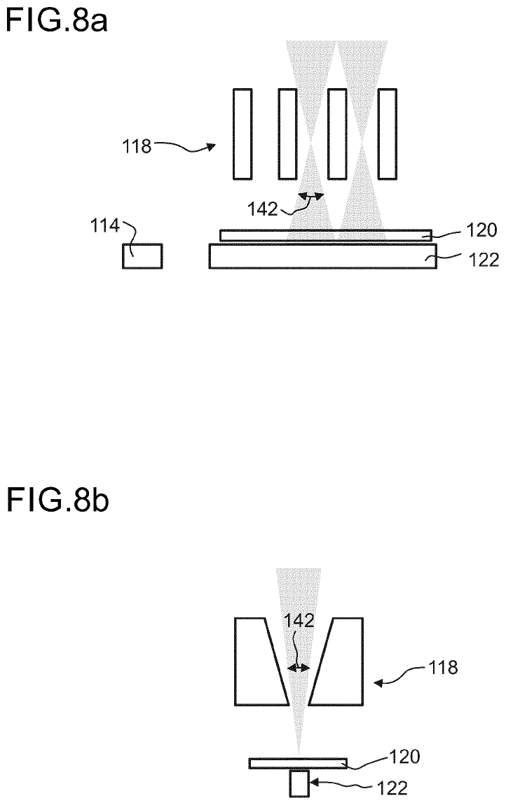

In FIG. 9, an embodiment of a spectrometer system 146 comprising the spectrometer device 110 is shown. Further, the spectrometer system comprises an electronics unit 148 configured for determining information regarding a spectrum by evaluating the at least one detector signal generated by the detector array 122 of the spectrometer device 110. In particular, the electronics unit 148 may comprise at least one data processor, such as a PC, a mobile device or a cloud device, and may specifically be configured for processing and/or storing data, such as the detector signal and/or a calculated absorbance of the sample 111. As an example, the electronics unit 148 may be operatively culpable to the spectrometer device 110, i.e. for transferring and/or exchanging data and/or information. The transfer and/or exchange of data is illustrated exemplarily in FIG. 9 by using arrows. The spectrometer device 110 may further comprise at least one driving unit 150, i.e. an LED driver, configured for controlling the at least one light-emitting element 112 and the at least one reference light-emitting element 114. Additionally or alternatively, the spectrometer device 110 may comprise at least one evaluation unit 152 configured for generating information related to the spectrum, i.e. the spectrum of the sample 111, from the detector signal by calculating the absorbance of the sample 111 from the detector signal depending on the location of the individual detector element 124 in the detector array 122. Again, the transfer and/or exchange of data between the electronics unit 148, the driving unit 150, the evaluation unit 152, and the spectrometer device 110, specifically the light emitting element 112, the reference light emitting element 114 and the detector array 122 are illustrated exemplarily in FIG. 9 by using arrows.

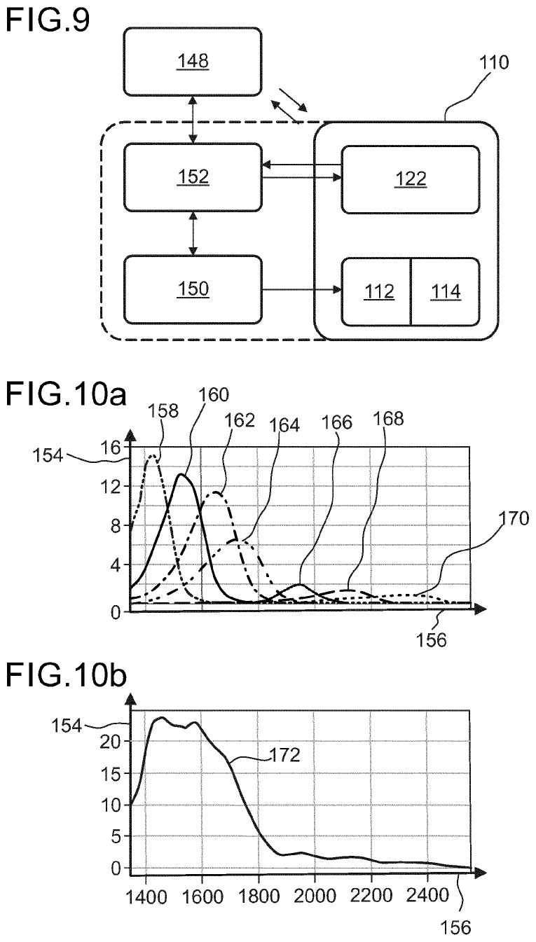

In FIGS. 10a and 10b, graphs of measurement signals of light emitted by a plurality of light emitting elements 112 of a spectrometer device 110 are shown. In particular, a power 154 in [μW/nm] of the emitted light may be shown over a wavelength 156 in [nm]. Specifically, in FIG. 10a, the graph shows measurement signals of light emitted by a plurality of light emitting elements 112 emitting light in seven contiguous wavelength spectral ranges of the measurement spectrum, wherein the seven measurement signals 158, 160, 162, 164, 166, 168 and 170 respectively have peaks at 1400 nm, 1500 nm, 1600 nm, 1700 nm, 1900 nm, 2100 nm and 2300 nm. FIG. 10b shows the cumulated signal 172 of the seven measurement signals 158, 160, 162, 164, 166, 168 and 170.

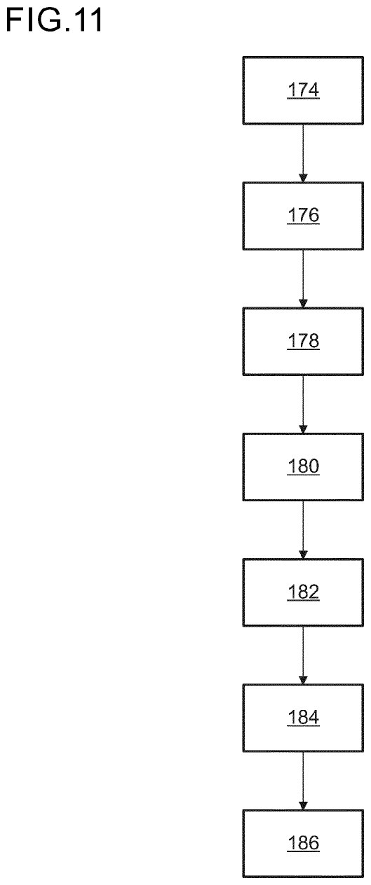

In FIG. 11, shows a flow chart of a method for determining at least one information related to a spectrum of a sample 111 with a spectrometer device 110. The method comprises the following steps:
a) (denoted with reference number 174) providing the spectrometer device 110;
b) (denoted with reference number 176) providing the sample 111;
c) (denoted with reference number 178) emitting light in a measurement spectrum by the at least one light emitting element 112, specifically by the at least one LED or miniaturized thin-film emitter;
d) (denoted with reference number 180) emitting light in a reference spectrum by the at least one reference light emitting element 114, specifically by at least one reference LED or miniaturized thin-film emitter;
e) (denoted with reference number 182) generating the detector signal by the detector array 122, specifically a measurement detector signal and a reference detector signal, according to an illumination of the plurality of detector elements 124;
f) (denoted with reference number 184) evaluating the at least one detector signal generated by the detector array 122 of the spectrometer device 110, specifically by using the evaluation unit 152; and
g) (denoted with reference number 186) determining the at least one information related to the spectrum of the sample 111.

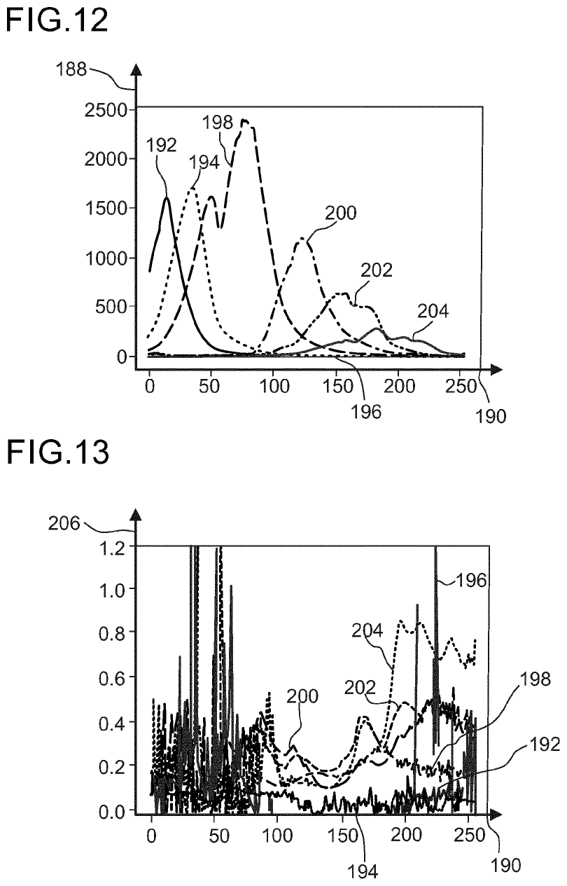

Specifically, step g) may comprise calculating the absorbance of the sample 111, specifically by using the evaluation unit 152. In this regard, as an example, numerous calculation approaches may be possible. In the example, illustrated in FIGS. 12 to 14, PET was used as a sample 111. In FIG. 12, the measurement signals for this sample are illustrated in a graph, wherein the measurement detector signal S 188 is shown over numbered pixels 190, i.e. over a total number of 256 detector elements 124 of the detector array 122. In this graph, sample signals 192 to 204 are shown resulting from measuring the sample 111 by using the spectrometer device 110 with light emitting elements 112 emitting light in seven contiguous wavelength spectral ranges of the measurement spectrum. In the graph, the seven sample signals 192, 194, 196, 198, 200, 202 and 204 were measured respectively from using light having peaks at 1400 nm with a frequency of 40 Hz, 1500 nm with a frequency of 48 Hz, 1600 nm with a frequency of 56 Hz, 1700 nm with a frequency of 64 Hz, 1900 nm with a frequency of 72 Hz, 2100 nm with a frequency of 80 Hz and 2300 nm with a frequency of 88 Hz.

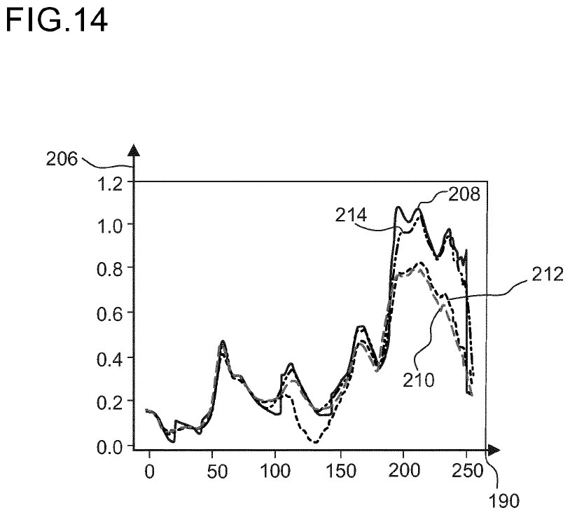

Further, in FIGS. 13 and 14, calculated absorbances 206 for the PET-sample are illustrated over the pixels 190, as calculated from the sample signals 192 to 204 illustrated in FIG. 12. For the graph illustrated in FIG. 13, the absorbances were calculated directly for each of the seven sample signals. Thus, for illustrational purposes, the absorbances illustrated in this graph are denoted using the same reference numbers as for the sample signals in FIG. 12. As can be seen in FIG. 13, the calculated absorbances for each of the sample signals show a high noise to signal ratio.

In FIG. 14, the absorbances were calculated using Equations 1 to 4 as outlined above. In particular, the first absorbance 208 was calculated by using Eq. 1. The second absorbance 210 was calculated by using Eq. 2, wherein n=7, and f₁=40 Hz, f₂=48 Hz, f₃=56 Hz, f₄=64 Hz, f₅=72 Hz, f₆=80 Hz and f₇=88 Hz. The third absorbance 212 was calculated by using Eq. 3, wherein the same frequencies f₁ to f₇ were used as for the calculation of the second absorbance 210. The fourth absorbance 214 was calculated by using Eq. 4, wherein the same frequencies f₁ to f₇ were used as for the calculation of the second and third absorbance 210 and 212. As an example, the second absorbance 210 might shows some ill-defined absorbances and therefore holes, whereas the third absorbance 212 appears to be smoother. Further, compared to the first absorbance 208, the third absorbance 212 seems to reveal less contrast. The preferred calculation approach, i.e. seemingly the best tradeoff between smoothness, contrast, and signal-to-noise ratio, appears to be the fourth absorbance 214.

### LIST OF REFERENCE NUMBERS

110 spectrometer device
111 sample
112 light emitting element
114 reference light emitting element
116 interface element
118 segmented aperture
120 optical separation element
122 detector array
124 detector element
126 first light emitting element
128 second light emitting element
130 third light emitting element
132 optical element
134 mirror
136 angle α
138 entrance opening
140 exit opening
142 angle θ
144 optical lens
146 spectrometer system
148 electronics unit
150 driving unit
152 evaluation unit
154 power [μW/nm]
156 wavelength [nm]
158 first measurement signal
160 second measurement signal
162 third measurement signal
164 fourth measurement signal
166 fifth measurement signal
168 sixth measurement signal
170 seventh measurement signal
172 cumulated signal
174 step a)
176 step b)
178 step c)
180 step d)
182 step e)
184 step f)
186 step g)
188 signal S
190 pixel
192 first sample signal
194 second sample signal
198 third sample signal
198 fourth sample signal
200 fifth sample signal
202 sixth sample signal
204 seventh sample signal
206 absorbance
208 first absorbance
210 second absorbance
212 third absorbance
214 fourth absorbance

1. A spectrometer device for analyzing a sample, comprising:
at least one light emitting element configured for emitting light in a measurement spectrum:
at least one reference light emitting element configured for emitting reference light in a reference spectrum, wherein the at least one reference light emitting element is separate from the at least one light emitting element;
at least one interface element configured for receiving light of the measurement spectrum and transferring light of the measurement spectrum to at least one detector array, wherein the interface element is further configured for blocking reference light of the reference spectrum:
at least one segmented aperture configured for acting as one or more of an angle filter and a stray light filter:
at least one optical separation element; and
the at least one detector array comprising a plurality of detector elements, wherein the detector array is configured for generating at least one detector signal according to an illumination of the plurality of detector elements by one or more of the measurement spectrum and the reference spectrum, wherein each detector element is configured for receiving at least a portion of one or more of the measurement spectrum and the reference spectrum.

2. The spectrometer device according to claim 1, wherein the interface element, the reference light emitting element and the detector array are arranged such that the light emitted by the reference light emitting element travels to the detector array along an optical reference path, wherein the optical reference path is fully arranged within the spectrometer device.

3. The spectrometer device according to claim 2, wherein the interface element is arranged such that the light emitted by the reference light emitting element is at least partially reflected by the interface element and that the light emitted by the light emitting element is at least partially transmitted by the interface element.

4. The spectrometer device according to claim 3, wherein the light emitting element and the reference light emitting element are arranged within a housing of the spectrometer device, wherein the interface element and the light emitting element are arranged such that the light emitted by the light emitting element is transmitted by the interface element and that light reflected by the sample is transmitted by the interface element wherein the interface element and the reference light emitting element are arranged such that the light emitted by the reference light emitting element is reflected by the interface element.

5. The spectrometer device according to claim 1, wherein the segmented aperture is disposed in an optical path in between the interface element and the detector array.

6. The spectrometer device according to claim 1, wherein the optical separation element is disposed in an optical path before the detector elements of the detector array, wherein the optical separation element is configured for separating light into a spectrum of constituent wavelength components, wherein each of the detector elements is configured for receiving at least a portion of one of the constituent wavelength components and for generating a respective detector signal depending on the illumination of the respective detector element by the at least one portion of the respective constituent wavelength component.

7. The spectrometer device according to claim 1, wherein the reference spectrum comprises electromagnetic radiation having smaller wavelengths than electromagnetic radiation comprised by the measurement spectrum.

8. The spectrometer device according to claim 1, wherein the at least one light emitting element is a light emitting diode (LED), wherein the at least one reference light emitting element is an LED.

9. The spectrometer device according to claim 8, wherein the at least one light emitting element and the reference light emitting element are infrared LEDs configured for emitting light in an infrared spectral range, such that the measurement spectrum and the reference spectrum lie within the infrared spectral range.

10. The spectrometer device according to claim 1, further comprising at least one driving unit configured for controlling the at least one light emitting element and the at least one reference light emitting element by one or more of turning the light emitting element on and/or off, turning the reference light emitting element on and/or off, modulating the measurement spectrum and modulating the reference spectrum, wherein the spectrometer device further comprises at least one evaluation unit configured to generate the information related to the spectrum from the detector signal by calculating an absorbance of a sample from the detector signal depending on a location of the individual detector element in the detector array.

11. A spectrometer system, comprising:
the spectrometer device according to claim 1; and
an electronics unit configured for determining information regarding a spectrum by evaluating the at least one detector signal generated by the detector array of the spectrometer device.

12. The spectrometer system according to claim 11, wherein the electronics unit comprises at least one data processor configured for processing and/or storing data wherein the at least one data processor is configured for processing and/or storing the calculated absorbance of the sample.

13. A method for determining at least one information related to a spectrum of a sample with the spectrometer device according to claim 1, the method comprising:
a) providing the spectrometer device;
b) providing the sample;
c) emitting light in a measurement spectrum by the at least one light emitting element;
d) emitting light in a reference spectrum by the at least one reference light emitting element;
e) generating the detector signal by the detector array according to an illumination of the plurality of detector elements;
f) evaluating the at least one detector signal generated by the detector array of the spectrometer device; and
g) determining the at least one information related to the spectrum of the sample.

14. The method according to claim 13, wherein step c) comprises modulating the light emitting element and wherein step d) comprises modulating the reference light emitting element and wherein step g) comprises calculating the absorbance of the sample and processing the calculated absorbance of the sample.

15. A method of using a spectrometer system according to claim 1, the method comprising using the spectrometer system in an application selected from the group consisting of an infrared detection application;
a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application; and a plastics identification and/or recycling application; a healthcare and/or beauty application.

16. The method according to claim 15, wherein the agricultural application comprises characterization of soil, silage, feed, crop or produce, or monitoring plant health.

17. The method according to claim 15, wherein the healthcare and/or beauty application comprises a determining of skin hydration and/or oxygen saturation in an animal or human skin, or a determining of an oxygen saturation in blood, urine, saliva or other bodily fluids.
